(19) United States
(12) Patent Application Publication
(10) Pub. No.: US 2009/0000948 A1
(43) Pub. Date: Jan. 1, 2009

(54) Methods for Improving Efficiency of Cell Electroporation Using Dielectrophoreses

(75) Inventors: Lei Wang, Beijing (CN); Lei Wang, Beijing (CN); Min Guo, Beijing (CN); Jing Cheng, Beijing (CN)

Correspondence Address: MORRISON & FOERSTER LLP, 755 PAGE MILL RD, PALO ALTO, CA, 94304-1018, US

(73) Assignee: Capital Bio Corporation

(21) Appl. No.: 12/097,409

(22) PCT Filed: Jan. 4, 2007
(86) PCT No.: PCT/CN2007/000012

§ 371 Date: Sep. 11, 2008

(30) Foreign Application Priority Data
Jan. 6, 2006 (CN) 200610011111.8

(51) Int. Cl. G01N 27/26; G01N 27/00

(52) U.S. Cl. 204/547; 204/643

(57) ABSTRACT

The present invention provides methods for enhancing the efficiency of cell electroporation using dielectrophoresis-assisted cell localization and uses thereof in a microfluidic biochip system. Cells are first subject to dielectrophoresis and localized to regions where the electric field intensity is high enough to render cells electroporated. The invention enhances the efficiency of in situ cell electroporation on a traditional microfluidic biochip.

### TECHNICAL FIELD

This application pertains to methods of improving efficiency of cell electroporation by using dielectrophoresis-assisted cell localization and microfluidic devices for high efficiency cell electroporation.

### BACKGROUND

The introduction of foreign genes, proteins, drugs, and other molecules into cells has a variety of important applications in life sciences and medical sciences, including studies of gene regulation, expression of recombinant proteins, gene therapy, and drug delivery. Seeking for a safe, effective, and highly efficient transfection method has become a major focus of research in the fields of life science and medical science.

Viruses are able to infect cells, and thus can be used as a vector for transfecting cells. A wide variety of viruses have been modified and utilized to carry foreign genes into cells. Kim et al., Oncogene, 2001, 20 (1), 16-23. However, virus-mediated cell transfection is frequently associated with risks such as infections and immune responses. In addition, the construction and large-scale production of viral vectors are very difficult.

Non-viral cell transfection methods such as chemical transfection methods have also been developed. For example, cation liposome-mediated transfection method has been developed. Felgner et al., Proc. Natl. Acad. Sci. 1987, 84(21), 7413-17. However, the transfection efficiency of these methods is usually lower than that of virus-mediated method. Furthermore, these methods are generally limited due to problems of chemical toxicity, unsuitability for microfluidic biochip systems, and other problems.

Cell transfection under electric field, i.e., electroporation, has also been developed. Leikin et al., Biol. Membr. 1986, 3, 944-951. This method utilizes electric field to produce a voltage difference between the inside and outside of the cell membrane, resulting in transit perforation on the cell membrane. The perforation of the cell membrane allows exogenous molecules, such as nucleic acids, proteins, and drug molecules, enter the cells.

Electroporation method has several advantages over other transfection methods. First, its transfection efficiency is higher than that of other transfection methods. Second, electroporation is a purely biophysical method and is free of chemical contamination or viral infection; third, electroporation omits the washing and rinsing steps after cell perforation, and is therefore particularly suitable for a microfluidic biochip system. Fourth, the processing conditions of electroporation can be easily controlled and reproduced. Furthermore, cell electroporation can be used for cells in various different states, such as cells growing in a suspension and cells that are adherent to a substrate.

Because not all cells can be localized to regions where the strength of the electric field is sufficient to cause cell perforation, cell electroporation efficiency using traditional electroporation method is very low. To expand regions where the strength of the electric field is sufficient to cause cell perforation, it is usually necessary to increase the voltage for electroporation. An increased voltage may, however, cause cell death due to over perforation in areas where the strength of the electric field is relatively higher. There is therefore a need for other effective ways to increase efficiency of cell electroporation.

Dielectrophoresis is a method for manipulating microparticles such as cells using electric fields. During dielectrophoresis, a nonuniform, alternating electric field is applied to microparticles such as cells, and the microparticles such as cells will move in an oriented direction in solution.

Dielectrophoresis and/or electroporation of cells have been disclosed, for example, in U.S. Pat. No. 6,916,656 and US Application No. 2003/0104588.

The disclosures of all publications, patents, patent applications and published patent applications referred to herein are hereby incorporated herein by reference in their entirety.

### BRIEF SUMMARY OF THE INVENTION

The present invention provides methods and devices for high efficiency cell electroporation. In one aspect, the present invention provides a method of improving efficiency of electroporation of cells, comprising: a) subjecting the cells to a first dielectrophoretic electric field which causes the cells to localize to an effective electroporation region (i.e., a region where an electric field at a strength sufficient to cause electroporation of the cells can be imposed); b) subjecting the cells to a second electric field which induces electroporation of the cells. In some embodiments, the first dielectrophoretic electric field is removed prior to the step of subjecting the cells to a second electric field, wherein the intensity of the second electric field is sufficient to cause electroporation of the cells. In some embodiments, the first dielectrophoretic electric field is maintained during the step of subjecting the cells to a second electric field, wherein the sum of the first dielectrophoretic electric field and the second electric field is sufficient to cause electroporation of the cells.

In some embodiments, there is provided a method of improving efficiency of electroporation of cells on a microfluidic device comprising a first set of electrodes and a second set of electrodes, comprising: a) applying a first electric signal to the first set of electrodes, wherein the first electric signal generates a dielectrophoretic electric field which causes the cells to localize to an effective electroporation region, and b) applying a second electric signal to the second set of electrodes (or a second electrode), wherein the second electric signal generates a second electric field which induces electroporation of the cells. In some embodiments, the first electric signal is removed prior to the application of the second electric signal, and the intensity of the second electric field generated by the second electric signal is sufficient to cause electroporation of the cells. In some embodiments, the first electric signal is maintained during the application of the second electric signal, wherein the sum of the first dielectrophoretic electric field generated by the first electric signal and the second electric field generated by the second electric signal is sufficient to cause cell electroporation.

In some embodiments, cell localization under dielectrophoretic electric field (i.e., dielectrophoresis) is carried out in a solution (such as a buffer or a cell culture medium). In some embodiments, the dielectrophoretic electric field causes positive conventional dielectrophoresis. In some embodiments, the dielectrophoretic electric field causes negative conventional dielectrophoresis.

In some embodiments, cells localized to an effective electroporation region are immediately subject to a second electric field. In some embodiments, cells localized to an effective electroporation region are cultured in situ prior to the step of subjecting the cells to a second electric field.

In some embodiments, there is provided a method of transferring a foreign agent to one or more cells, comprising: a) subjecting the cells to a first dielectrophoretic electric field which causes the cells to localize to an effective electroporation region; b) subjecting the cells to a second electric field in the presence of a foreign agent, wherein the second electric field induces electroporation of the cells, and wherein the foreign agent enters at least one cell. In some embodiments, there is provided a method of transferring a foreign agent to one or more cells on a microfluidic device comprising a first set of electrodes and a second set of electrodes (or a second electrode), comprising: a) applying a first electric signal to the first set of electrodes, wherein the first electric signal generates a dielectrophoretic electric field which causes the cells to localize to an effective electroporation region, and b) applying a second electric signal to the second set of electrodes (or a second electrode) in the presence of the foreign agent, wherein the second electric signal generates a second electric field which induces electroporation of the cells, and wherein the foreign agent enters at least one cell. In some embodiments, the foreign agent is selected from the group consisting of nucleic acids, proteins, or drug molecules.

In another aspect, there is provided a microfluidic device for electroporation of cells, comprising: a) a substrate, b) a first set of electrodes for generating a first dieletrophoretic electric field, wherein the first dielectrophoretic electric field can cause cells to localize to an effective electroporation region; and c) a second set of electrodes (or a second electrode) for generating a second electric field, wherein the second electric field can induce electroporation of the cells.

Also provided herein are uses of the methods and devices described herein for transporting foreign agents such as nucleic acids, proteins, and small molecules into cells.

### BRIEF DESCRIPTION OF THE FIGURES

FIG. 1 provides a schematic diagram of an exemplary microfluidic device for high efficiency cell electroporation of the present invention.

### DETAILED DESCRIPTION OF THE INVENTION

The present invention provides methods of enhancing the efficiency of cell electroporation using dielectrophoresis-assisted cell localization. Specifically, the invention makes use of cell dielectrophoresis to localize cells to regions where effective electroporation can be carried out, thereby improves the efficiency of cell electroporation. The invention involves manipulation of cells under electric field, and is suitable for microfluidic devices and automation.

In one aspect, the invention provides a method of improving efficiency of electroporation of cells, comprising: a) subjecting the cells to a first dielectrophoretic electric field which causes the cells to localize to an effective electroporation region; b) subjecting the cells to a second electric field which induces electroporation of the cells.

“Dielectrophoretic electric field” refers to a spatially non-uniform electric field, which generates an electric force on microparticles (such as cells). As is further elaborated below, when a cell is placed in a spatially non-uniform electric field, the electrical forces pulling on each half of the cell are unbalanced, resulting in a net force that propels the cell to either the maximum electric field intensity (positive conventional dielectrophoresis) or minimum field intensity (negative conventional dielectrophoresis). The direction of the force depends on the properties of the cell, the media, the applied electric field, or a combination thereof. Typically, an AC voltage wave, such as a sine wave, is applied across electrodes to produce an alternating electric field. The specific voltage, frequency, and duration of the sine wave depends on the specific cell types.

Provided below is further elaboration of typical dielectrophoresis. The dielectrophoretic force is expressed as:

[symbol]

_{DEP}=2π∈ₘr³(Re(f_{CM})∇Eᵣₘₛ²+Im(f_{CM})(Eₓ₀²∇φₓ+E_{y0}²∇φ_{y}+E_{z0}²∇φ_{z})) (1)

where

r is the particle radius,

∈ₘ is the permittivity of the medium for suspending the particle,

Eᵣₘₛ is the root-mean-square (rms) value of electric field strength, and

Factor f_{CM}=(∈*ₚ−∈*ₘ)/(∈*ₚ+2∈*ₘ) refers to the dielectric polarization factor (also known as the Clausius-Mossotti factor).

The complex permittivity is defined as ∈*ₓ=∈ₓ−jσₓ/(2πf).

The dielectric polarization factor relates to the frequency f of the applied electric field, the conductivity σₓ, the permittivity of the particle (denoted as p), and the permittivity of the medium for suspending the particle (denoted as m).

From formula (1), it can be seen that the dielectrophoretic force generally consists of two components: conventional dielectrophoresis force (cDEP) and traveling wave dielectrophoresis force (twDEP). The cDEP force is related to the in-phase component of the dipole moment induced on the particle by the applied electrical field caused by the interaction of the gradient (∇Eᵣₘₛ²) of the field strength. The item of the in-phase component the dipole moment induced on the particle by the applied electrical field, Re(f_{CM}), i.e., the real part of factor f_{CM}, is the polarization factor of the conventional dielectrophoresis. The twDEP is related to the out-of-phase component of the dipole moment induced on the particle by the applied electrical field, caused by the interaction of the gradient of the electrical phase (∇φₓ, ∇φ_{y} ∇φ_{z}). The item of the out-of-phase component of the dipole moment induced on the particle by the applied electrical field, Im(f_{CM}), i.e., the imaginary part of factor f_{CM}, is the polarization factor of the traveling wave dielectrophoresis. It is worthy of pointing out that if the phase distribution of the field strength of an electric field is non-uniform, the electric field is a traveling wave electric field. The electric field extends along the direction of the gradually decreasing value of the phases, which change with different positions. The phase distribution of the ideally-traveling electric field, along the traveling direction of the electric field, is a linear function of the positions. Thus, the conventional dielectrophoretic force is the force imposed on a particle due to the uneven distribution of the applied alternating electric field.

The conventional dielectrophoretic force experienced by a particle having the radius of r and placed in a non-uniform electrical field, [symbol] _{cDEP}, is expressed as:

[symbol]

_{cDEP}=2π∈ₘr³χ_{DEP}∇Eᵣₘₛ² (2)

where

Eᵣₘₛ is the root-mean-square (rms) value of electric field strength,

∈ₘ is the permittivity of the medium.

The formula (2) above representing the conventional dielectrophoretic force and the general expression formula representing the dielectrophoretic force above are consistent. Factor χ_{cDEP} is the polarization factor of the conventional electrophoresis of a particle, and can be expressed as

$${χ}_{cDEP} = Re ( \frac{{ɛ}_{p}^{*} - {ɛ}_{m}^{*}}{{ɛ}_{p}^{*} + 2 {ɛ}_{m}^{*}} ) \qquad ( 3 )$$

where

Re as used here is the real part of the plural, and Symbol ∈*ₓ=∈ₓ−jσₓ/(2πf) is the complex permittivity. Perimeters ∈ₚ and σₚ are the effective permittivity and the conductivity of the particle, respectively (possibly associated with the frequency of the applied electrical field). For example, typical biological cells have the conductivity and the permittivity associated with the frequency (at least partly due to the induction of the polarization on the cell membrane).

When the conventional dielectrophoresis polarization factor of a particle is positive (χ_{cDEP}>0), the particle will be driven to move towards the strong field region by the conventional dielectrophoretic force, which is called as positive conventional dielectrophoresis. The conventional dielectrophoretic force that causes the positive conventional dielectrophoresis movement of the particle is called the positive conventional dielectrophoretic force.

When the conventional dielectrophoresis polarization factor of a particle is negative (χ_{cDEP}<0), the particle will be driven to move off the strong field region and towards the weak field region by the conventional dielectrophoretic force, which is called as negative conventional dielectrophoresis. The conventional dielectrophoretic force that causes the negative conventional dielectrophoresis movement of the particle is called the negative conventional dielectrophoretic force.

In some embodiments, the cell dielectrophoresis is carried out in a solution, such as a buffer or a cell culture medium. In some embodiments, cells are placed in conductive media such as saline for negative conventional dielectrophoresis. In some embodiments, cells are placed in low conductivity buffer for positive conventional dielectrophoresis.

The amplitude voltage ranges for the dielectrophoretic electric field depend on arrangement of the electrode and the conductivity of the solution. Typical range of the voltage is about 0.5 to about 10 V. In some embodiments, the dielectrophoretic electric field is a non-uniform electric field generated by the application of an AC voltage directly on electrically conductive electrodes. Suitable conductive electrodes include, but are not limited to, metal, non-metal, or a combination thereof. In some embodiments, the dielectrophoretic electric field is a non-uniform electric field generated by the application of an AC voltage indirectly on an insulating medium. Suitable insulating medium include, but are not limited to, glass, silicon, polymeric material, or a combination thereof.

As mentioned above, application of dielectrophoretic electric field to cells can effectively localize the cells in the region where the electroporation can be carried out effectively. Upon the cell localization, a second electric field can be imposed to induce electroporation. This can effectively improve the efficiency of perforation.

An “effective electroporation region” refers to a region where an electric field at strength sufficient to cause electroporation of the cells can be imposed. In some embodiments, the effective electroporation region is the region defined by the electrodes for electroporation. The effective electroporation region can be physically defined with trapping means so that cells localized to the effective electroporation region are unable to move out of the region. In some embodiments, the effective electroporation is not physically defined.

Electroporation uses pulsed electric field to cause cell permeabilization. In a typical electroporation, the membrane voltage, Vₘ, at different loci on phospholipid bilayer spheres during exposure in a homogenous electric field of duration t, can be calculated from:

Vₘ=1.5r_{c}E cos α[1−exp(−τ/t)] (1)

where E is the electric field strength, r_{c} is the cell radius, α is the angle in relation to the direction of the electric field, and t is the capacitive-resistive time constant. Pore-formation will result at spherical coordinates exposed to a maximal potential shift, which is at the poles facing the electrodes (cos α=1 for α=0; cos α=−1 for α=π). The electric field intensity that is sufficient to trigger electroporation depends on the type of the cells. For example, electric field strengths on the order of from 0.5 to 1.5 kV/cm (such as 0.75 kV/cm) for durations of a few μs to a few ms are sufficient to cause transient permeabilization in 10-μm-outer diameter spherical cells. In some embodiments, the cells are mammalian cells and the electric field strength is about 0.1 to 4 KV/cm, such as about 1 to about 4 KV/cm. The effective electroporation region can also be defined by the desired voltage between cell membranes. For example, the voltage between cell membranes is typically about 0.25 V to about 1 V, including for example about 0.5 V to about 1V.

The methods of the present invention utilizes dielectrophoresis to localize cells to a region where an electric field at a strength sufficient to cause electroporation of the cells can be imposed. Electroporation is triggered, i.e., induced, by a second electric field. In some embodiments, the electric field that causes electroporation can derive from the second electric field and is independent of the dielectrophoretic electric field. In this configuration, the strength or intensity of the second electric field alone is sufficient to cause electroporation, and the first dielectrophoretic electric field is removed prior to the step of subjecting the cells to a second electric field.

Alternatively, in some embodiments, the electric field for electroporation derives from the combined force of both the first dielectrophoretic electric field and the second electric field. In this configuration, the sum of the first dielectrophoretic electric field and the second electric field is sufficient to cause electroporation, and the first dielectrophoretic electric field is maintained during the step of subjecting the cells to a second electric field. In some embodiments, the ratio of the strength of the dielectrophoretic electric field and the second electric field is about any of 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10.

Cells described herein include, but are not limited to, mammalian cells (such as human cells, 3T3 cells, 293 cells, COS cells, CHO cells, rat cells, or mouse cells), prokaryotic cells (such as bacteria), and eukaryotic cells (such as yeast and insect cells). Once localized to an effective electroporation region, the cells (typically in cell suspensions) can be immediately exposed to a second electric field which induces cell electroporation. Alternatively, the cells are cultured in situ for a period of time prior to the step of subjecting the cells to a second electric field.

Upon electroporation, the electroporated cells may be transported to storage containers for further manipulation or culturing. For example, the cells may be cultured on a microfluidic chip for further on-chip studies or long-term studies. The cells can be cultured for several hours to several days, depending on the cell type and the culture medium.

Cell electroporation methods described herein are useful for transferring a variety of foreign agents into the cells. These include, but are not limited to, nucleic acids, proteins, or drug molecules. In some embodiments, there is provided a method of transferring a foreign agent to one or more cells, comprising: a) subjecting the cells to a first dielectrophoretic electric field which causes the cells to localize to an effective electroporation region; b) subjecting the cells to a second electric field in the presence of a foreign agent, wherein the second electric field induces electroporation of the cells, and wherein the foreign agent enters at least one cell. In some embodiments, there is provided a method of transferring a foreign agent to one or more cells on a microfluidic device comprising a first set of electrodes and a second set of electrodes (or a second electrode), comprising: a) applying a first electric signal to the first set of electrodes, wherein the first electric signal generates a dielectrophoretic electric field which causes the cells to localize to an effective electroporation region, and b) applying a second electric signal to the second set of electrodes (or a second electrode) in the presence of the foreign agent, wherein the second electric signal generates a second electric field which induces electroporation of the cells, and wherein the foreign agent enters at least one cell.

In some embodiments, the foreign agent is a nucleic acid. In some embodiments, the foreign agent is a protein. In some embodiments, the foreign agent is a drug molecule. Other suitable foreign agents include, but are not limited to, small molecules, siRNAs, synthetic peptides, dyes (such as fluorescent dyes, including for example GFP and Rhodamine).

In another aspect, there is provided a microfluidic device for highly efficient cell electroporation. The microfluidic device comprises a first set of electrodes for generating a dielectrophoretic electric field and a second set of electrodes (or a second electrode) for generating a second electric field. For example, in some embodiments, the microfluidic device comprises a) a substrate, b) a first set of electrodes for generating a first dieletrophoretic electric field, wherein the first dielectrophoretic electric field can cause cells to localize to an effective electroporation region; and c) a second set of electrodes (or a second electrode) for generating a second electric field, wherein the second electric field can induce electroporation of the cells.

The first and second set of electrodes are preferably electrodes of cellular to subcellular dimensions. For example, the outer dimension of the ends of the electrodes can be from about 10 nanometer to about 100 micrometers, more preferably about 1 to about 30 micrometers and most preferably approximately 10 micrometers. The electrodes can be made of a solid electrically conducting material, or they can be hollow for delivery of different agents. The electrodes can be made from different materials. For example, one special type of electrodes are hollow and made from fused silica capillaries of a type that frequently is used for capillary electrophoresis and gas chromatographic separations. These capillaries are typically one to one hundred micrometers in inner diameter, and five-to-four hundred micrometers in outer diameter, with lengths between a few millimeters up to one meter.

The electrodes described herein can be either movable or fixed. In some embodiments, the electrodes form arrays. For example, the electrodes can be in interdigitated structure forming an electrode array.

The electrodes can be fabricated on-chip in variety of materials. For example, metal electrodes can be deposited on silicon using evaporation or sputtering methods.

In some embodiments, the microfluidic device comprises microchannels. For example, cells can be localized to an effective electroporation region by moving along microchannels. In some embodiments, the device comprises a chamber within which the cells can move and localized under dielectrophoretic forces.

The first and second set of electrodes can be made of the same or different materials. Suitable electrodes include, but are not limited to, metal, non-metal, or combination thereof.

The substrate of the microfluidic device can be fabricated in a variety of materials, including bit not limited to, plastic, polymer, silicon, silicone, glass, etc, using known microfabrication methods.

The microfluidic device can further comprise one or more of the following: 1) containers for cells to be electroporated; 2) microchannels for supplying cells from the containers; 3) containers for foreign agents to be transferred into cells; 4) microchannels for supplying foreign agents; 5) containers for cells that are electroporated; and 6) microchannels for transferring cells from electroporation region to containers.

In some embodiments, the microfluidic device comprises multiple containers for different types of cells and/or different agent. In some embodiments, the microfluidic device comprises multiple microchannels for transporting different cells and agents. For example, the network of microchannels and containers may each contain a different gene fragment or pharmaceutically active compound, which can be delivered and electroporated into the cells of interest via microchannels and integrated (or external) microelectrode systems. Such microfluidic systems may be integrated with on-chip fabricated electrodes, or can be interfaced with external electrode systems. Such systems can also be fabricated from a number of substrate materials, including glass, silicon, teflon, or any number of other suitable plastics, such as polyethylene, polymethyl methacrylate, and polydimethylsiloxane.

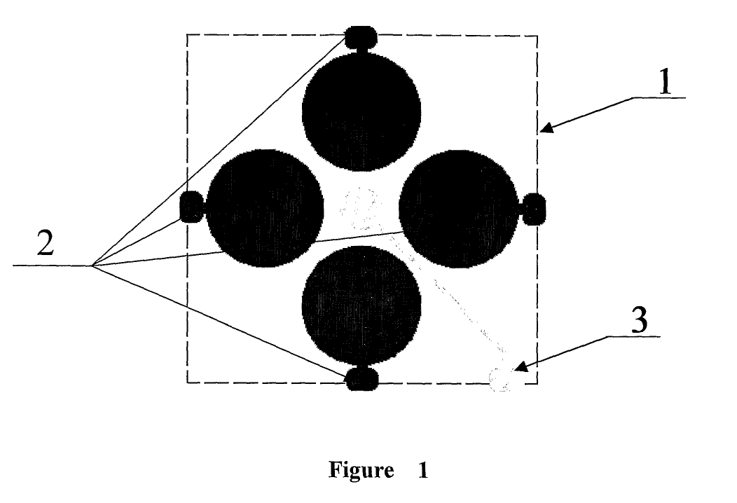

FIG. 1 provides an exemplary microfluidic device (1) of the present invention. A first set of microelectrodes (2) are configured to generate dielectrophoretic electric field on cells and localize cells to an effective electroporation region where a second set of microelectrode (3) is localized. The second set of microelectrode generates a second electric field which induces electroporation.

Although the foregoing invention has been described in some detail by way of illustration and example for purposes of clarity of understanding, it is apparent to those skilled in the art that certain minor changes and modifications will be practiced. Therefore, the description and examples should not be construed as limiting the scope of the invention.

1. A method of improving efficiency of electroporation of cells, comprising:
a) subjecting the cells to a first dielectrophoretic electric field which causes the cells to localize to an effective electroporation region;
b) subjecting the cells to a second electric field wherein the second electric field induces electroporation of the cells.

2. The method of claim 1, wherein the first dielectrophoretic electric field is removed prior to the step of subjecting the cells to a second electric field, wherein the intensity of the second electric field is sufficient to cause electroporation of the cells.

3. The method of claim 1, wherein the first dielectrophoretic electric field is maintained during the step of subjecting the cells to a second electric field, wherein the sum of the first dielectrophoretic electric field and the second electric field is sufficient to cause electroporation of the cells.

4. The method of claim 1, wherein cell dielectrophoresis is carried out in a solution.

5. The method of claim 4, wherein the solution is a buffer or a buffer or a cell culture medium.

6. The method of claim 1, wherein cells localized to the effective electroporation region are cultured in situ prior to the step of subjecting the cells to a second electric field.

7. The method of claim 1, wherein the dielectrophoretic electric field causes the cells to undergo negative conventional dielectrophoresis.

8. The method of claim 1, wherein the dielectrophoretic electric field causes cells to undergo positive conventional dielectrophoresis.

9. The method of claim 1, wherein the dielectrophoretic electric field is a non-uniform electric field generated by the application of an AC voltage directly on electrically conductive electrodes.

10. The method of claim 9, wherein the conductive electrodes are metal, non-metal, or a combination thereof.

11. The method of claim 1, wherein the dielectrophoretic electric field is a non-uniform electric field generated by the application of an AC voltage indirectly on an insulating medium.

12. The method of claim 11, wherein the insulating medium is glass, silicon, polymeric material, or a combination thereof.

13. The method of claim 1, wherein the cells are mammalian cells.

14. Use of a method of claim 1 for transferring a foreign agent into the cells.

15. The use of claim 14, wherein the foreign agent is a nucleic acid, a protein, or a drug molecule.

16. A microfluidic device for electroporation of cells, comprising
a) a substrate,
b) a first set of electrodes for generating a first dieletrophoretic electric field, wherein the first dielectrophoretic electric field can cause cells to localize to an effective electroporation region; and
c) a second set of electrodes for generating a second electric field, wherein the second electric field can induce electroporation of the cells.

17. The microfluidic device of claim 16, wherein the first set of the electrodes are metal, non-metal, or combination thereof.

18. The microfluidic device of claim 16, wherein the second set of the electrodes are metal, non-metal, or combination thereof.

19. The microfluidic device of claim 16, wherein the first set of the electrodes and the second set of electrodes are made of different materials.

20. The microfluidic device of claim 16, wherein the substrate is glass, silicon, polymeric material, or a combination thereof.
